(19) United States
(12) Patent Application Publication
(10) Pub. No.: US 2024/0243320 A1
(43) Pub. Date: Jul. 18, 2024

(54) MEMBRANE FOR PROTON CONDUCTION

(71) Applicants: Thomas Häring, Stuttgart (DE); Davina Häring, Stuttgart (DE)

(72) Inventors: Thomas Häring, Stuttgart (DE); Davina Häring, Stuttgart (DE)

(21) Appl. No.: 18/280,171

(22) PCT Filed: Mar. 1, 2022
(86) PCT No.: PCT/IB2022/000197

§ 371 Date: Mar. 25, 2024

(30) Foreign Application Priority Data
Mar. 1, 2021 (WO) PCT/DE2021/000037

(51) Int. Cl. H01M 8/1025; H01M 8/10; H01M 8/18

(52) U.S. Cl. CPC H01M 8/1025; H01M 8/188; H01M 2008/1095; H01M 2300/0082

(57) ABSTRACT

The invention relates to a membrane for proton conduction, made of a proton-conducting polymer for use in redox flow batteries. The polymer is sulfonated poly(ether ketone ether ketone ketone) (PEKEKK). The membranes are efficient, mechanically stable, oxidation-resistant in VO₂⁺ with sulfuric acid, and exhibit long-term stability in the unblended state. The membranes can be used for several hundred to a thousand hours in vanadium redox flow batteries having black start capacity. Formula I, PEKEKK with a sulfonic acid group and an IEC of 1.73 meq/g.

Description: In many applications of membrane technology, a selective transport of ions is desired. In monoselective cation exchange membranes, for example, this is a selective transport of monovalent cations compared to divalent or polyvalent cations through the membrane. Another example are redox flow batteries.

Here, the highest possible proton transport through the membrane is desired with a simultaneous low transfer of other cations through the membrane. The cations can also be organic cations or stable organic radicals.

Examples of such redox flow batteries are vanadium redox flow batteries or Ironchrome redox flow batteries. The passage of unwanted cations or radicals through the membrane is also called crossover. A vanadium-redox-flow-battery, abbreviated VRFB in the following, has in the charged state on one side Vanadium ions in the state +5 (V⁺⁵) and on the other side vanadium ions in the state +2 (V⁺²). In the discharged state, +4 (V⁺⁴) and +3 (V⁺³)—cations are opposite each other. The chambers with the cations are separated by a membrane. The construction of an VRFB has been state of the art since the 1990s. The VRFB consists of two chambers that are separated in the middle by a membrane. In addition to the electrolyte, the chambers also contain electrically conductive fleeces, which are connected via conductive electrodes. In most cases, carbon materials are used for the construction of the fleeces and electrodes. The further electrical construction is not discussed here. It is generally known and irrelevant for the description of the invention. If the battery is discharged protons flow through the membrane to balance the charge.

In the case of an ideal perfect membrane for the VRFB and many other electrochemical applications, no other particles or masses move through the membrane apart from the protons. In reality, however, water, metal cations and other molecules such as acids or added auxiliary substances move through the membrane along with the protons. In the VRFB, the vanadium cations and the passage of water are relevant. A passage of cations, e.g. vanadium cations leads to an imbalance, therefore to an imbalance of the charge carriers. The consequence is a direct loss of the capacity of the electrolytes. A self-discharge of the battery then takes place via the membrane. This process of the undesirable cation transport takes place during charging, discharging and when the battery is at a standstill.

Depending on the operating state of the battery, charging or discharging, the cations move in one direction or the other.

In any case, the crossover of cations through the membranes is undesirable and should be kept as low as possible. However, measures that increase the selectivity of the membrane for proton-cation discrimination often lead to an increase in the resistance of the desired proton conduction. To solve this problem, anion-exchange membranes were developed for VRFB. In this process, sulphate anions rather than protons are transported through the membrane to balance the charge. In the case of the iron-chromium redox flow battery, these are chloride ions. Due to the positive fixed charge of the anion exchange membrane, the cations are largely prevented from passing through the membrane. Because the transport of sulphate anions is slower than the transport of protons, the resistance of the battery is higher overall. At low currents, however, the advantage of the selectivity of the anion exchange membrane outweighs the disadvantage of the increase in resistance. As a result, the energy efficiency, abbreviated as EE in the following, increases. Energy efficiency is understood to be the ratio of power input to power output. Example: 90% EE means that if 1 kWh of energy flowed into the battery during charging, 0.9 kWh was drawn from it during discharging. The EE is the product of the Voltage efficiency and the Coulomb efficiency.

The Voltage efficiency is a measure of the total resistance of the battery and the Coulomb efficiency is a measure of the selectivity of the membrane.

A membrane for the VRFB, the iron-chromium RFB or similar batteries with proton flux as charge balance, must have a high selectivity as well as a high chemical stability towards the electrolytes used. In the VRFB it is about vanadium sulfates, which are in 35 to 50% wt. sulfuric acid are dissolved.

In further embodiments, further additives are added to the electrolyte, e.g. hydrochloric acid or phosphoric acid. A problem that arises is the strong oxidation potential of the 5-valent vanadium cation. Vanadium (+5) VO₂⁺ is reduced to vanadium (+4) by the oxidation itself. This is then present as VO₂⁺. Many membrane materials that have sufficient selectivity are not permanently stable in vanadium (+V). An example is sulfonated poly-ether-ether-ketone. A membrane made of this material or blends with this material are not stable over the long term in the VRFB. After just a few weeks or less than 1000 charge-discharge cycles, these membranes become non-selective and disintegrate. Depending on the polymer, the membranes fail after less than 50 cycles. Another example is polystyrene sulfonic acid.

However, for a commercial and technical application the long-term stability of the material is the decisive criterion. For this reason, perfluorinated polymers with strongly acidic sulfonic acid groups have become established among the cation exchange materials. The best-known representative is Nafion® from DuPont. In simplified terms, this is polytetrafluoroethylene with attached sulfonic acids in a side chain that is also fluorinated. The disadvantage of fluorinated materials is the comparatively high price and, due to the fluorine used, a poor environmental balance. During operation, the chain breaks and fragments split off over the years. These are toxic and persistent in the environment. The membranes are difficult to dispose of after “end-of-life”. Recycling is in fact not possible. The fluorinated membranes are hazardous waste after use.

The advantage of the anion exchange membranes already described is their lower crossover of metal cations. Their disadvantage is their higher resistance or their reduced current density, since the transported anions need considerably more time to cross the membrane. The current density is the power per unit area. As a rule, the unit is milliwatts per centimeter squared [mW/cm²].

Another disadvantage is that most long-term stable anion exchange membranes use non-functionalised fluorinated polymers for mechanical stabilisation. These fluorinated polymers are soluble in aprotic solvents, which is a requirement for the manufacture of the blend membranes. The polymers used are polyvinylidene fluoride and polyvinylidene fluoride (PVDF) or related polymers. This results in the environmental and disposal problems already described.

Fluorine-free mechanical reinforcement materials have the problem that they are not stable over time in vanadium +5.

The applicant is not aware of any non-fluorinated sulfonated material that can be used for many thousands of hours and tens of thousands of cycles in the VRFB.

In addition, a high selectivity for protons against metal cations with a simultaneously low proton conduction resistance is necessary.

Sulfonated polysulfones, sulfonated polyaryletherketones, and a variety of blends of sulfonated polymers with other materials have been extensively studied in the literature for their use in VRFB. The result is always the same, any measure that improves selectivity, chemical stability or mechanical stability, increases resistance to proton conduction or results in a material with inferior properties to the perfluorinated sulfonic acids already tried and used.

EP1856188A 1 by Kreuer et al. describes an oxidation-stable polysulfone with a low electron content in the main chain and pendant sulfonic acid groups. The unblended material allows a high degree of sulfonation and thus also has a correspondingly high proton conductivity. However, this material has the disadvantage that it is not mechanically stable in its pure form. It's very brittle. The problem can be solved by mixing, i.e. blending, the material with mechanically stabilizing polymers. A material that is often used for this is polybenzimidazol (PBI). An acid-base blend is formed. The blend is based on the principle of ionic interaction between part of the polymeric acid and a polymeric base. The disadvantage here is that positively charged nitrogen, in this case the protonated imidazole ring, is formed in the membrane.

However, as a charge, this opposes the proton transport. From Kerres et al. Detailed studies have been published on this. I.e. the ionic resistance increases and the proton conduction decreases.

Irrespective of this, PBI is not long-term stable in vanadium +5. It is oxidized. In terms of performance and longevity in the VRFB, cation exchange membranes consisting of perfluorinated copolymers with sulfonic acid groups in the side chain (Nafion®) have been the benchmark material to date. They are mechanically stable, even when dry, have the lowest proton conduction resistance and are long-term stable to vanadium +5 or other oxidative agents, e.g. radicals that are formed during operation.

Disadvantages are their high crossover of metal cations and water, the higher acquisition costs (expensive fluorine chemistry) and their non-existent recyclability.

Membranes based on anion exchange polymers have been the benchmark material to date when it comes to low crossover numbers and the resulting high energy efficiency values.

At high currents, the fluorine-based cation exchange membranes are superior to the anion exchange membranes. Another disadvantage is that the anion exchange membranes pumps water around when the VRFB is in operation. The water balance is uneven with every loading and unloading process. As a result, this must be taken into account in the system. This usually happens by transferring electrolyte from one electrolyte chamber to the other. However, the charge is destroyed in the process. In a single stack the loss is acceptable, in a large plant with several MW power it reduces the plant economics and lowers the EE.

Another disadvantage in the anion exchange membranes is the use of fluorine containing polymers as mechanical reinforcement in the long-term stable membranes. Long-term stability in this context means the use of the membrane in a redox flow battery for at least three years. Service lives of 5 to 10 years and more are required by users.

The task is therefore to provide a material for the VRFB that is fluorine-free, has a high proton conductivity, has a low crossover of metal cations from the electrolyte and is long-term stable compared to vanadium +5 in sulfuric acid. In addition, it should be cheaper than the previously used membranes based on perfluorinated polymers with sulfonic acids. The material should be recyclable after use “end-of-life” or easy to dispose of. And the material should be mechanically stable when dry and when moistened or swollen.

### DESCRIPTION

Surprisingly, such a material was found. It is stable over tens of thousands of hours of operation and has been tested over tens of thousands of charge-discharge cycles without degeneration. At the same time, it is highly selective towards metal cations. It is mechanically stable both dry and swollen and has high proton conductivity. It is recyclable and can be easily disposed of. Membranes made of sulfonated PEKEKK from an ion exchange capacity (IEC) of 1.0 milliequivalent per gram (meq/gr,) and from a thickness of approx. 25 μm are mechanically stable, not brittle, self-supporting and under normal humidity conditions of >50% in a temperature range of 0 up to 110° C. flexible and partially elastic. This also applies to the highly sulfonated membranes with an IEC >3.5 meq/gr.

It is sulfonated poly-ether-ketone-ether-ketone-ketone (PEKEKK). The optimal degree of sulfonation for PEKEKK is on average one sulfonic acid group per repeating unit. This represents an optimum for use in VRFB, with the respective optimum always resulting from the interaction of the average molecular weight and the degree of sulfonation. For a starting polymer molecular weight of 30,000 to 35,000 dalton, there is approximately one sulfonic acid group per repeat unit of the polymer. This value of the sulfonated PEKEKK gives an ion exchange capacity (IEC) of 1.73 milliequivalents per gram, abbreviated IEC=1.73 meq/gr. In the further description, unless otherwise stated, sulfonated PEKEKK is abbreviated to SPEKEKK. For a PEKEKK with an average molecular weight of about 65,000 to 75,000 Dalton, the optimum degree of sulfonation is about 1.5 groups and the IEC is 2.3 to 2.5 meq/gr. The sulfonation of PEKEKK with oleum, described below, is known. However, there was no reason to believe that sulfonated PEKEKK would have superior properties in the VRFB. The most common representative of the polyaryletherketones is PEEK. However, tests of sulfonated PEEK in the VRFB showed that the material does not have sufficient long-term stability. The same applies to the polysulfones with the exception of Kreuer et.al. developed material. However, this material alone does not form self-supporting films, is brittle and must therefore be blended or mechanically reinforced. This in turn changes the properties negatively.

In addition to the high oxidative stability to vanadium +5, sPEKEKK has none detectable desulfonation reaction in the VRFB.

However, the stability towards vanadium +5 does not explain the very low crossover values of vanadium ions in the VRFB.

The crossover values are very low, especially when the VRFB is at rest. There is currently no final explanation for this. It is assumed that there is an interaction between the vanadium cations and the keto groups of the polymer, which then leads to a repulsive polarization of the membrane towards other vanadium cations.

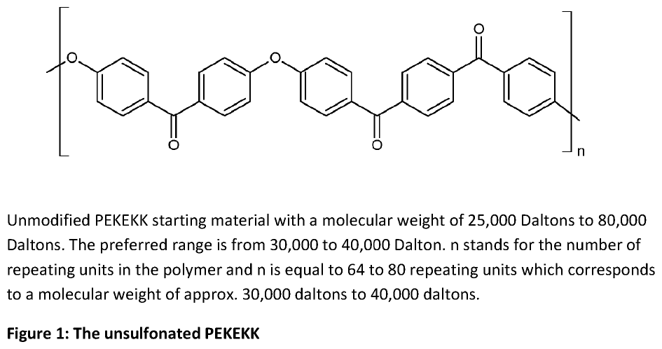

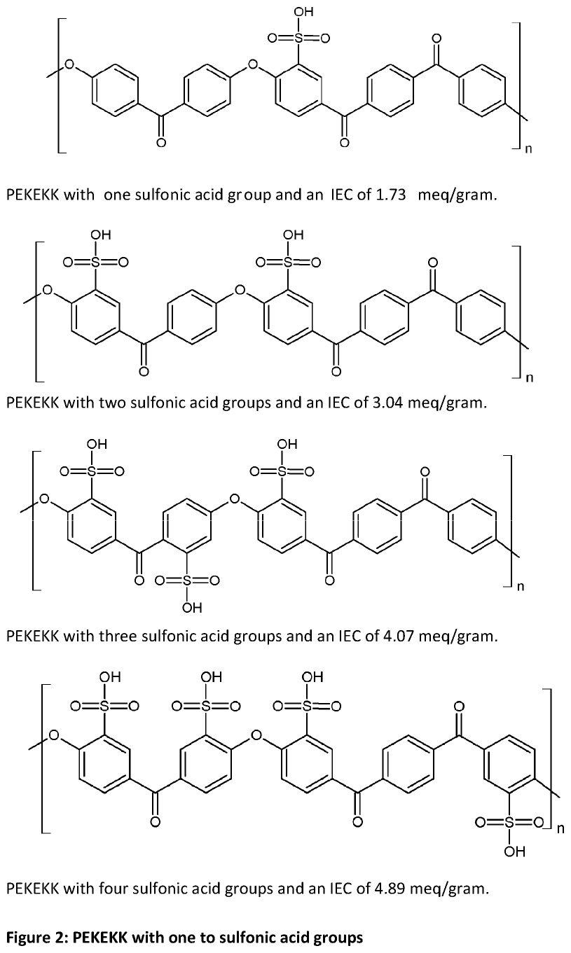

See FIG. 1 the unsulfonated PEKEKK.

The material is stable in any concentration of vanadium (+5) in sulfuric acid, with sulfuric acid having a concentration of up to 65%.

Typically, the sulfuric acid concentration in the VRFB is between 35 and 55% by weight. Higher concentrations of sulfuric acid do not occur in the VRFB. Likewise, no degeneration can be detected if hydrochloric acid or phosphoric acid is present in addition to the sulfuric acid. There is no cleavage of the sulfonic acid group, as in the case with sulfonated polyetheretherketone (PEEK), for example. Sulfonated polysulfones such as Udel® PSU or Radel-R® or Radel-AR® also split off the sulfonic acid group, or oxidize to vanadium +5.

After sulfonation, all of the polysulfones listed and examined below split off the sulfonic acid group again at different rates under the influence of vanadium +5 in 30-60% sulfuric acid. The effect of desulfonation under acidic, oxidative conditions has already been described for the group of polyethersulfones. The polysulfones examined are listed in the attached table 4.

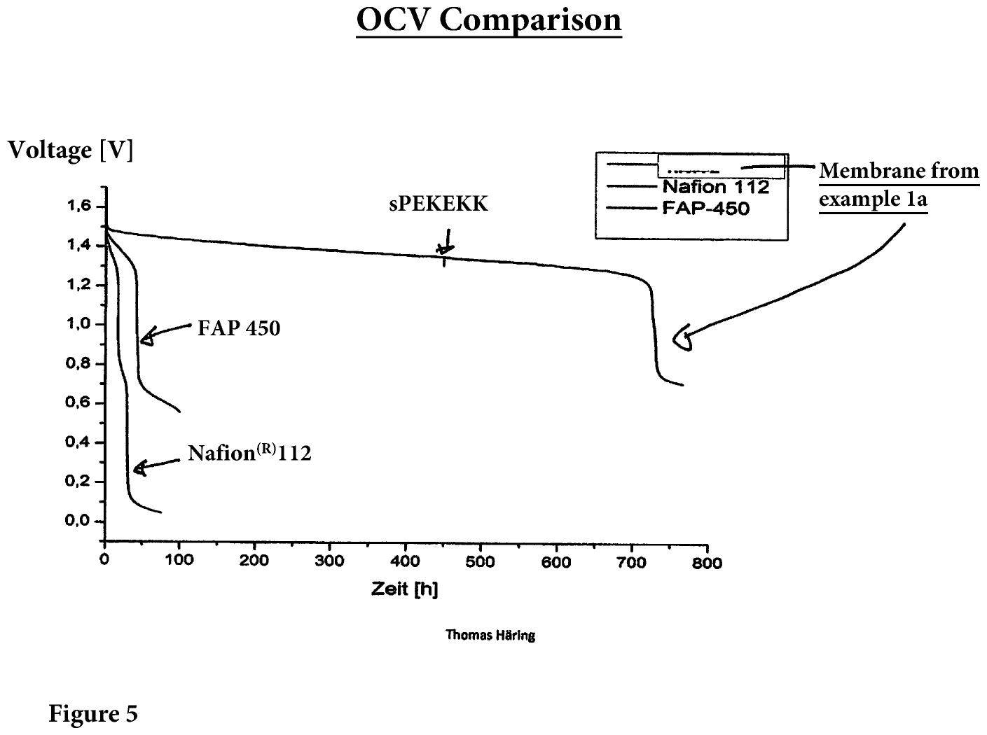

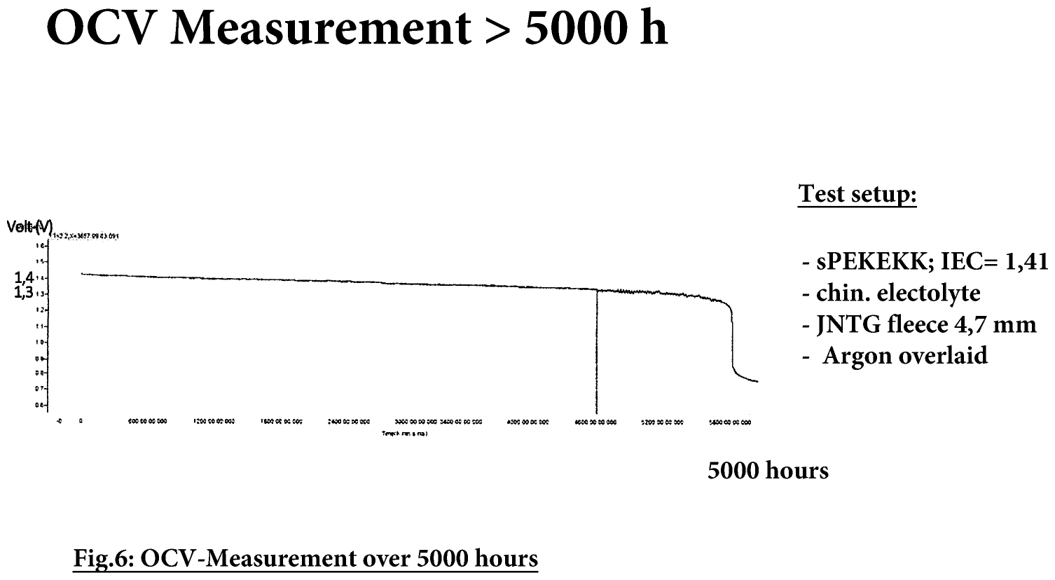

There is an optimum of maximum proton conductivity and selectivity towards vanadium cations in the VRFB for sPEKEKK. This is at a level of sulfonation of one group per repeat unit of the polymer. Converted to ion exchange capacity (IEC), this is a value of 1.73 to 1.78 milliequivalents/gram (meq/g). If the IEC of the sulfonated PEKEKK is below but still above the percussion limit for protons, the selectivity increases, but so does the resistance to proton conduction. The percussion limit is the value from which ions, here protons, move from one side of the membrane to the other side. This value is approximately an IEC of 0.9 meq/g for sulfonated fluorine-free membranes. Excellent crossover values are obtained for membranes with an IEC of 1.3 to 1.5 meq/gr. achieved, see FIGS. 5 and 6.

If the IEC is above 1.78 meq/g, the proton conductivity increases further, but the selectivity towards vanadium cations decreases significantly. The material is still long-term resistant to vanadium (+5). A desulfonation reaction does not take place.

Membranes made of sulfonated PEKEKK with an IEC of 0.9 to 2.7 meq/g have been successfully tested in the VRFB in a large number of tests over a total of several 10,000 cycles and up to twelve years. In this process, membranes were developed which have better values than any other material known to the applicant, both in terms of selectivity and proton conductivity. The membranes are better than all known materials in terms of voltage efficiency, Coulomb efficiency and thus also energy efficiency. The crossover of the membranes is so low that the VRFB batteries are capable of black starts for over 700 hours. In a particular embodiment, the black start capability increases to more than three months. Capable of black starts is understood to mean that the self-discharge of the battery or of a stack of the entire battery in the open cell voltage does not fall below the value of 1.3 volts per cell in the time specified above. This value is determined by measuring the open cell voltage. This property is important for the operation of the VRFB as an emergency power generator or as part of an uninterruptible power supply (UPS). Black start capability is particularly important in the event of a widespread power blackout. The energy of black-start capable redox flow batteries can then be used to start up non-black-start capable power generating units.

The open cell voltage, also no-load voltage, (English open-circuit voltage, OCV) is in electrical engineering at the terminals of an open voltage source measured electrical voltage. This means that the no-load voltage is the voltage on the output side when no load is connected.

### EXAMPLES

Example 1a: Preparation of sulfonated PEKEKK 1 kg of PEKEKK, as a powder with an average molecular weight of 32,000 daltons, is dissolved in 10 liters of concentrated sulfuric acid (>99% wt.). Thereafter, the solution is mixed with stirring (KPG stirrer) with sulfur trioxide until a 20% by weight sulfur trioxide solution has formed, so-called 20% oleum, and stirring is continued.

The reaction vessel is maintained at 50° C. during the addition of sulfur trioxide. Samples are taken at intervals of 15 minutes, these are precipitated in water, washed free of acid and the degree of sulfonation is determined by titration.

The sulfonation reaction to about one sulfonation group is complete after about 5 to 36 hours. The value over time varies greatly because even small deviations in temperature or in the water content of the starting materials have a strong influence on the reaction rate. It is therefore necessary to continuously monitor the reaction by titrating samples.

When the desired sulfonation value is reached, here IEC from 1.7 to 1.95 meq/g, the reaction is stopped by cooling the now sulfonated polymer in the vessel and precipitating it in water. For example, the reaction mixture can be introduced into water under pressure in a thin stream. The reaction can also be stopped first by carefully introducing 90 to 95% strength sulfuric acid. And then the polymer is precipitated in water and washed with demineralized water until no more sulfuric acid can be detected in the washing water. A barium chloride solution, for example, is used as a detection method, or the outflow of the washing water is continuously checked for acid and washed-out substances with a pH meter or additionally with a conductivity meter.

The polymer is dried and ground to a powder. The IEC of the sulfonated polymer is between 1.7 and 1.95 meq/g.

To remove further low-molecular sPEKEKK, the polymer can also be mixed with water at a higher temperature of 50° to 80° C. and the rinsing water can be passed through an ultrafiltration system with a cut-off of 5,000 to 20,000 daltons. The permeate is fed back to the rinsing.

Example 1b: The procedure is as in Example 1a, with the difference that the sulfonation reaction is terminated at an IEC of about 1.4 meq/gram.

Example 1c: The procedure is as in example 1a, with the difference that the sulfonation reaction is stopped at an IEC of about 2.2 to 2.4 meq/gram.

Example 2: Manufacture of the membranes 100 g each of the powdered and purified sulfonated polymer from Examples 1a, 1b and 1c are dissolved in one liter of dimethylacetamide (DMAc) or N-methylpyrrolidone {NMP) and then applied to a stretched carrier film to form a membrane. The solvent is evaporated on a dryer section at a temperature between 60° C. and 170° C. and the film is then detached from the carrier. Instead of DMAc or NMP, other aprotic polar solvents such as DMSO or sulfolane can also be used. The membranes are cleaned of residual solvent by post-treatment in dilute sulfuric acid or hydrochloric acid. The membranes are then rinsed with demineralized water at a temperature of 30° to 40° until the pH of the washing water is neutral.

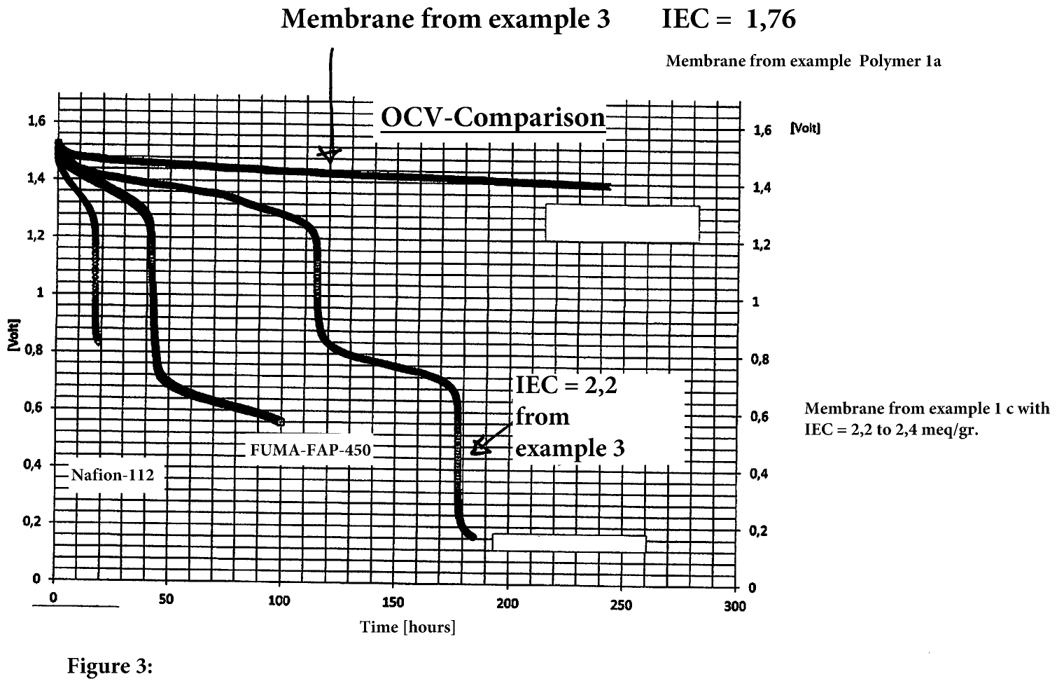

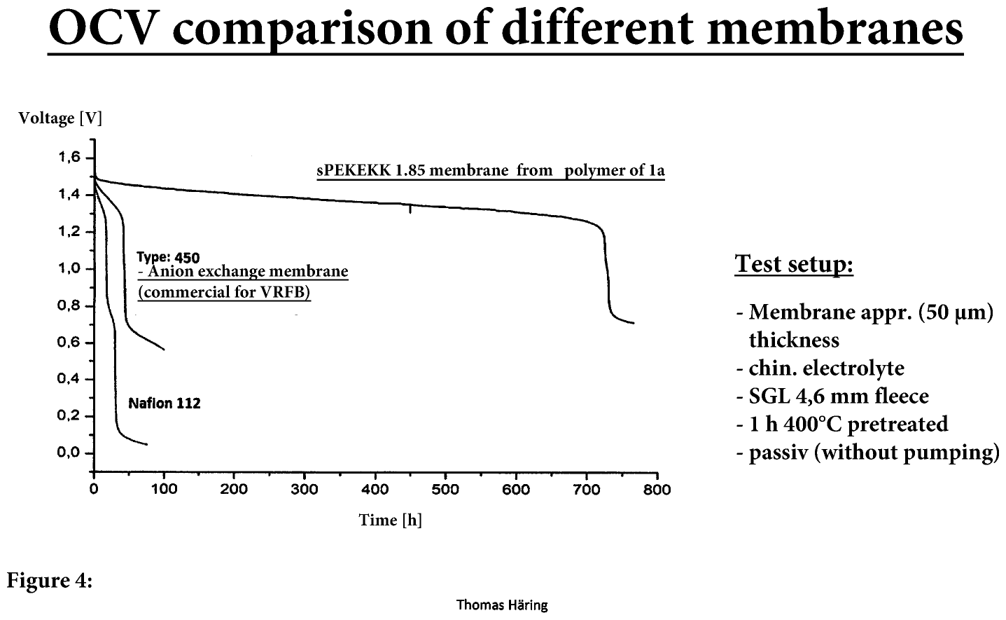

Example 3: The film from example 2 is tested as a membrane in a VRFB test cell and in stacks (FIGS. 3 to 6). Results are in Tables 1 and 2 after the figures.

Example 4: In the same test cells and stacks from Example 3, a membrane made of a sulfonated perfluorinated polymer, Type Nation® 112, is tested under identical conditions. Comparative results are given in FIGS. 3 to 5 and in Tables 1 and 2.

Example 5: In the same test cells and stacks from example 3, a commercial anion exchange membrane for the VRFB, type “450”, is tested under identical conditions. The “450” type is a benchmark membrane for anion exchange membranes in the VRFB.

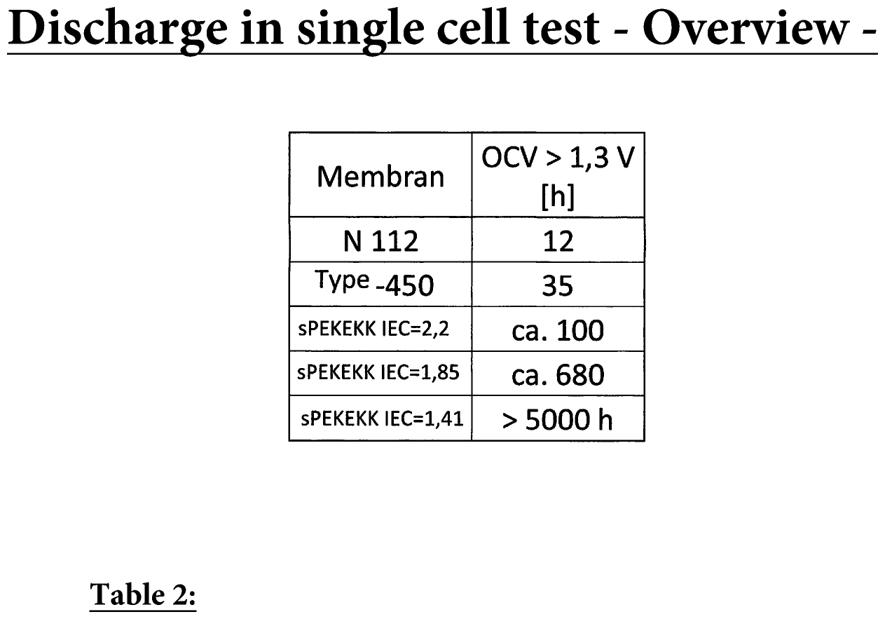

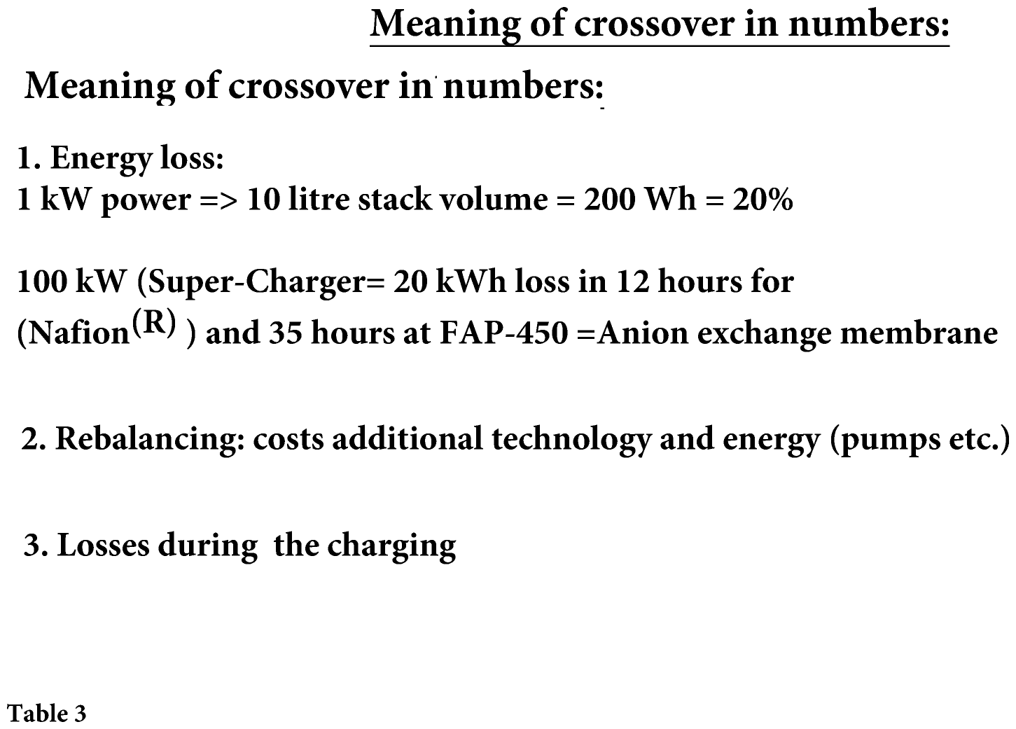

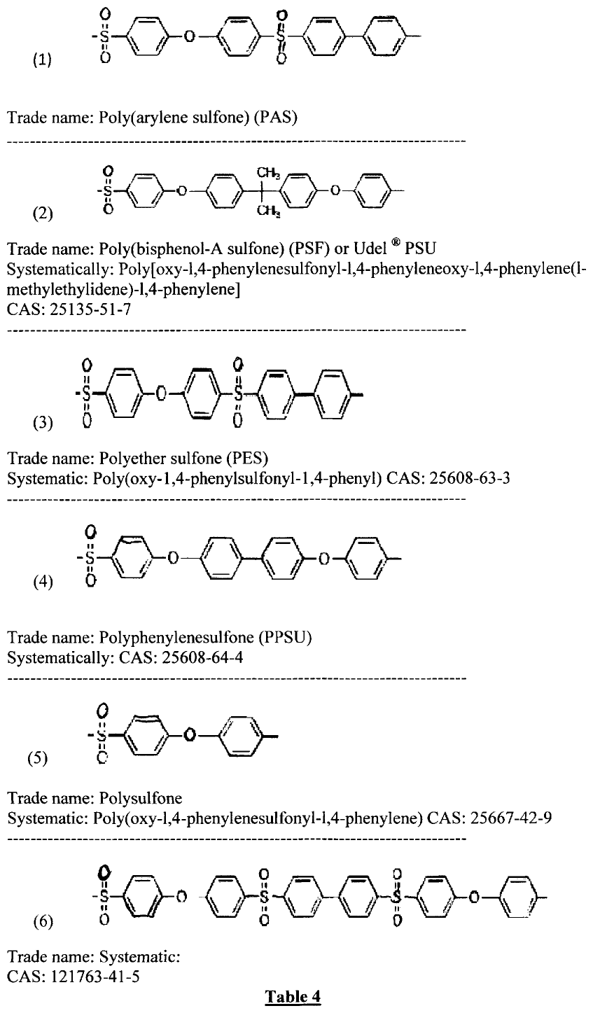

As can be seen from the graphs, the membrane according to the invention keeps the open cell voltage many times better than the commercially available comparison membranes Nation@ 112 and Type “450” (FIGS. 3 to 10).

In addition, it has a higher proton conductivity, a higher Coulomb efficiency and a higher energy efficiency than the comparison membranes (Table 1 and 2). It is stable for more than 5000 hours in the VRFB and more than 4000 cycles.

The applicant is not aware of any comparable membrane material.

Since the conditions in the VRFB can be classified as chemically very aggressive, it is easy for a person skilled in the art to see that the material can also be used for a large number of other membrane applications. These include electrolysis, membrane fuel cells, electrodialysis, reverse electrodialysis, reverse electrodialysis with bipolar membranes (RED-BP) and membrane processes that require selectivity from monovalent cations to divalent cations and to protons. In addition, membranes with sPEKEKK are excellently suited for their application as humidifier membranes for fuel cells and as high-temperature humidifiers.

Another application is in sensor technology. Membranes containing sPEKEKK are oxidation-resistant to oxidative agents. They resist vanadium +5 cations in 40 to 60% wt. sulfuric acid lasting over 20,000 hours with no detectable degeneration. The reduction in molecular weight of unpurified sPEKEKK over the course of three years was determined by means of GPC. In addition, samples were rinsed at a defined temperature of 50° C. until the pH and conductivity of the rinsing water were constant and then dried and the resulting weight was determined. A membrane weight loss of up to 10% occurred in the first month. This increased by around 1% per year over the next three years. Upon closer analysis, it turned out that the weight loss resulted from low molecular weight fragments. If the starting polymer was carefully freed from low-molecular fragments before processing to form the membrane, then the loss was reduced to 1 to 5%. The fluctuations depend on the complexity of the cleaning process.

Blends of the material with other polymers are also claimed for applications that require particular cation selectivity or particular electrochemical stability. Mixtures with PVDF, PBI and/or PES are very particularly preferred. Particular preference is given to using the blends in an oxidizing environment in which, for example, blends using sulfonated PEEK or electron-rich polysulfones are not long-term stable. Not long-term stable means that the material has been shown to degrade over several hours, so that the material fails completely after 3000 hours at the latest. Conversely, blends of sPEKEKK and PES or PSU, both polysulfones, are monovalent cation-selective and more than 10 to 100 times more stable to oxidation than sulfonated PSU or PES with the same IEC.

The degradation of sulfonic acid groups, desulfonation, is detected by first determining the sulfonic acid group content of the starting material either by infrared spectroscopy (FT-IR in ATR mode with diamond tip) or titration. These are common procedures.

Then the material is placed in vanadium (+5) sulfate in 50% sulfuric acid at 30° C. A material sample is taken every 24 hours. Washed with water until all sulfuric acid and vanadium salts are removed and then redetermined for sulfonic acid group content.

The degree of desulphonation can be determined by comparing the initial data with the final data. For long-term tests, the sulfonic acid groups are determined using the ATR-FT-IR method. This analysis has the advantage of being non-destructive. After the measurement, the sample is placed back into the vanadium (+5) sulphate in 50% sulfuric acid at 30° C. A 30 μm thick membrane made of sulfonated PEEK is so destroyed after 40 days at the latest that it can no longer be used as a sealed membrane. The electrolytes permeate through the membrane almost unhindered.

The comparison membrane made of sulfonated PEKEKK is almost unchanged even after 9 months and has 95% of its initial values. Degradation of the sulfonic acid groups cannot be detected. The measured loss of capacity of the membrane due to sulfonic acid groups results from the leaching out of low-molecular, water-soluble components of the sulfonated polymer. sPEKEKK membranes made from washed sulfonated starting polymers with a lower molecular weight of 25,000 daltons of the unsulfonated starting polymer and an average molecular weight of 37,000 to 42,000 daltons of the unsulfonated starting polymer show no degradation of the sulfonic acid groups even after more than three years.

The results from the examples and further comparative examples with the corresponding details are shown in the accompanying figures. The open cell voltage or the no-load voltage of a comparison stack with 10 cells and of individual cells are shown in the figures. The membranes all had a thickness of about 50 μm to 80 μm. The sPEKEKK membranes used have a thickness of between 40 μm and 60 μm. All other materials used, such as electrolytes and carbon fleece and electrodes, as well as contact pressures are identical in the respective experimental setup.

In a long-term self-charging test, a sPEKEKK membrane was tested for over 5000 hours. The IEC of the membrane was 1.41 meq/gram (FIG. 6). In the practical application this means a black start capability of several thousand hours, in a 3 cell stack the black start capability of this membrane is reduced to 2500 hours. However, the cause here was a pinhole in one of the membranes. A stack with 5 cells with a sPEKEKK of a IEC=1.63 meq/gram still had an OCV of 1.35 volts in an OCV test after 3500 hours. Before being processed into a membrane, the sPEKEKK was freed from low-molecular fractions using ultrafiltration (UF). The UF cut-off was between 10,000 and 15,000 daltons.

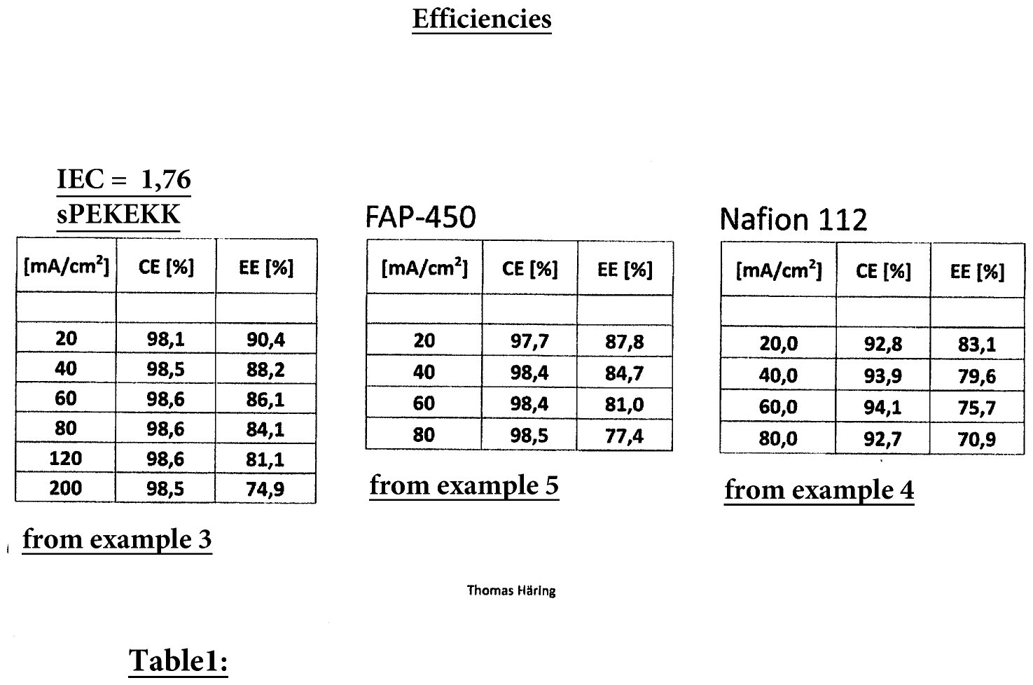

In a further test, a cycle endurance test of 100,000 cycles was run in a passive cell over several months (FIG. 7). The electrolytes were not pumped around and no rebalancing was carried out. Rebalancing is the technical term for compensating for differences in electricity in order to restore capacity lost through crossover. The test was aborted after 100,000 cycles because the test electronics were being used elsewhere.

Membranes made of sPEKEKK show the highest energy efficiency, with the lowest self-discharge at the same time, with the same good efficiency. The membranes are less expensive than fluorinated or partially fluorinated membranes. They are halogen-free and recyclable. Their disposal is easy. Incineration is not a problem, nor is redissolution in aprotic solvents. sPEKEKK is also biodegradable by fungi. The pH should then not be below 1. In practice, the stacks are dismantled after end-of-live and the membranes with the fleeces are most likely burned.

In redox flow batteries, especially in the VRFB, sPEKEKK membranes have the proton conductivity of membranes made of sulfonated perfluorinated polymers (Nafion® type) and the cation retention of anion exchange membranes. The membranes open up new areas of application for the RFB and especially the VRFB. Combined VRFB systems with super-electrolytic capacitor stores are currently being developed. The aim is to couple the advantage of the capacitors, the rapid change between charging and discharging processes, with the large capacity of the VRFB. Systems with the sPEKEKK membranes also allow rapid load changes with a very high number of cycles at the same time.

Due to the high efficiency, rebalancing is very easy. The membranes show a balanced water balance. There is an excess of pumped water, but this is so small that it can only be determined after a large number of cycles using appropriate measuring technology. In comparison, the perfluorinated sulfonic acids (Type Nafion@) and also the commercial anion exchange membranes for the VRFB (Type 450) pumped around a multiple of the electrolyte volume of water in the same time.

For this test, individual cells were charged and discharged. Two procedures were distinguished. First the passive operation and second the active operation. In passive operation there was no recirculation of the electrolyte. The test cells and stacks were charged and then discharged again.

In active operation the electrolyte of the cell was powered by a pump each side, the anode chamber and the cathode chamber, is slowly pumped around. In both modes of operation, no excess electrolyte was balanced from the anode side to the cathode side and vice versa. After less than 100 cycles, whether active or passive, a clear imbalance in the volumes of the electrolyte chambers developed in the comparison membranes. The anion exchange membranes had to be balanced after less than 100 cycles, otherwise continued operation was no longer possible. The perfluorinated sulfonic acid membrane pumped less liquid compared to the anion exchange membrane, but still much more than the sPEKEKK membrane. The self-discharge was twice as high in the perfluorinated sulfonic acid membrane (Type Nafion®) compared to the anion exchange membrane.

When comparing the OCV values, the sPEKEKK membranes are up to several thousand hours better than the comparison membranes. The reference membranes used, made of sulfonated perfluorinated polymers (Nafion), are installed in large redox flow battery systems in the order of tens of thousands of square meters per year (as of 2019).

Sulfonated sPEKEKK with more than two sulfonic acid groups per repeat unit in the polymer is water soluble. Highly sulfonated sPEKEKK having three to four sulfonic acid groups per repeat unit is also soluble in 30 to 50% wt. sulfuric acid. It was surprisingly observed that the crossover numbers of vanadium ions during operation under load of a VRFB were reduced by up to 20% compared to operation without the soluble sPEKEKK components in the electrolyte. The electrolytes were up to 5% wt. sPEKEKK added. The IEC of the added sPEKEKKs was between 3.4 and 4.2 meq/g. The soluble sPEKEKK was added to both the cathodic compartment and the anode compartment.

1-15. (canceled)

16. A redox flow battery comprising vanadium and a sulfonated polyetherketonetherketoneketone (sPEKEKK).

17. The redox flow battery of claim 16, wherein the sPEKEKK is provided in a flat membrane or a hollow fiber.

18. The redox flow battery of claim 16, wherein the sPEKEKK is dissolved in a sulphuric acid electrolyte and wherein the sPEKEKK is sulphonated at two or more functional groups in each repeating unit.

19. The redox flow battery of claim 16 wherein sulfonation is performed on a starting polymer comprising polyetherketonetherketoneketone (sPEKEKK) with an average molecular weight between 20,000 and 80,000 daltons, preferably between 25,000 and 50,000 daltons, and even more preferably between 30,000 and 40,000 daltons.

20. The redox flow battery of claim 16, wherein the sPEKEKK is sulfonated to an average of between 0.9 and 2.0 sulfonic acid groups per repeating unit, and preferably to an average of between 1.0 and 1.5 sulfonic acid groups per repeating unit.

21. The redox flow battery of claim 16, wherein the sPEKEKK is sulfonated to an average of between 3.0 and 4.0 sulphonic acid groups per repeating unit.

22. The redox flow battery of claim 17, wherein the sPEKEKK in the membrane has an average of between 0.9 and 4.0 sulphonic acid groups per repeating unit.

23. The redox flow battery of claim 17, wherein the sPEKEKK is maintained in a sulfuric acid electrolyte for a period of at least 2000 h, wherein the sulfuric acid electrolyte comprises pentavalent vanadium ions and sulphate in a 50% sulphuric acid, and wherein the SPEKEKK retains 90% of its initial capacity of sulphonic acid groups over the period.

24. The redox flow battery of claim 17, wherein the sPEKEKK is maintained in a sulfuric acid electrolyte for a period of at least 10000 h, wherein the sulfuric acid electrolyte comprises pentavalent vanadium ions and sulphate in a 50% sulphuric acid, and wherein the sPEKEKK retains 90% of its initial capacity of sulphonic acid groups over the period.

25. The redox flow battery of claim 17, wherein the sPEKEKK is maintained in a sulfuric acid electrolyte for a period of at least 80000 h, wherein the sulfuric acid electrolyte comprises pentavalent vanadium ions and sulphate in a 50% sulphuric acid, and wherein the SPEKEKK retains 90% of its initial capacity of sulphonic acid groups over the period.

26. A vanadium redox flow battery (VRFB) storage system comprising one or more membranes that include a sulfonated polyetherketonetherketoneketone (sPEKEKK) and one or more stacks of battery cells configured for a black start capability.

27. The VRFB storage system of claim 26, wherein the black start capability has a rated time period that exceeds 100 hours, and wherein an open cell voltage of each battery cell stack exceeds maintained at 1.3 volts over the rated time period.

28. The VRFB storage system of claim 26, wherein the black start capability has a rated time period that exceeds 500 hours, and wherein an open cell voltage of each battery cell stack exceeds maintained at 1.3 volts over the rated time period.

29. The VRFB storage system of claim 26, comprising one or more electrolyte chambers, provided an open cell voltage of each membrane exceeds 1.3 volts over 100 hours at 25° C. from an initial open cell voltage at or above 1.53 volts.

30. The VRFB storage system of claim 26, comprising one or more electrolyte chambers, provided an open cell voltage of each membrane exceeds 1.3 volts over 500 hours at 25° C. from an initial open cell voltage at or above 1.53 volts.

31. The VRFB storage system of claim 26, comprising one or more electrolyte chambers, wherein the electrolyte chambers are each coated with oxygen-free gas, preferably argon.
